(19) United States
(12) Patent Application Publication
(10) Pub. No.: US 2026/0172794 A1
(43) Pub. Date: Jun. 18, 2026

(54) EVENT-BASED NETWORK AND BLOCK CHAIN FORMATION

(71) Applicant: QUALCOMM Incorporated, San Diego, CA (US)

(72) Inventors: Danlu ZHANG, San Diego, CA (US); William WHYTE, Natick, MA (US); Edwin Chongwoo PARK, San Diego, CA (US); Jason FILOS, Newark, NJ (US); Dan VASSILOVSKI, Del Mar, CA (US); Bala RAMASAMY, San Marcos, CA (US); Benjamin LUND, Escondido, CA (US); Patrick HUGHES, Carlsbad, CA (US); Anand PALANIGOUNDER, San Diego, CA (US); Lorenzo CASACCIA, Barcelona (ES); Michael Franco TAVEIRA, San Diego, CA (US)

(21) Appl. No.: 19/126,226

(22) PCT Filed: Nov. 1, 2023
(86) PCT No.: PCT/US2023/078381

§ 371 Date: Apr. 30, 2025

(30) Foreign Application Priority Data
Dec. 14, 2022 (GR) 20220101034

(51) Int. Cl. H04W 4/40; H04W 76/10

(52) U.S. Cl. CPC H04W 4/40; H04W 76/10

(57) ABSTRACT

Systems and techniques for recording event data are described. In some implementations, a method may generate a network formation request based on an event. In some examples, the method may broadcast the network formation request to one or more targets. In some cases, the method may form a network including at least one of the one or more targets. In some aspects, the method may obtain, from at least one of the one or more targets, event data associated with the event. In some implementations, the method may append the event data associated with the event obtained from the one or more targets to a blockchain.

### FIELD

The present disclosure generally relates to event-based network formation between devices and event data recording. For example, aspects of the present disclosure relate to network formation between vehicles initiated based on a dangerous driving condition and storage of data related to the dangerous driving condition.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in V2X, vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

Blockchain technology has gained attention in many fields outside the domain of cryptocurrencies. Blockchain has the ability to build trust in a decentralized, distributed and autonomous way through a distributed database with all the electronic transactions or events registered in a transparent ledger and shared among the participating members.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods, and computer-readable media for recording event data. According to at least one example, a method is provided for recording event data. The method includes: generating a network formation request based on an event; broadcasting the network formation request to one or more targets; forming a network including at least one of the one or more targets; obtaining, from at least one of the one or more targets, event data associated with the event; and appending the event data associated with the event obtained from the one or more targets to a blockchain.

In another example, an apparatus for recording event data is provided that includes at least one memory and at least one processor coupled to the at least one memory. The at least one processor is configured to: generate a network formation request based on an event; broadcast the network formation request to one or more targets; form a network including at least one of the one or more targets; obtaining, from at least one of the one or more targets, event data associated with the event; and append the event data associated with the event obtained from the one or more targets to a blockchain.

In another example, a non-transitory computer-readable medium is provided that has stored thereon instructions that, when executed by one or more processors, cause the one or more processors to: generate a network formation request based on an event; broadcast the network formation request to one or more targets; form a network including at least one of the one or more targets; obtaining, from at least one of the one or more targets, event data associated with the event; and append the event data associated with the event obtained from the one or more targets to a blockchain.

In another example, an apparatus for recording event data is provided. The apparatus includes: means for generating a network formation request based on an event; means for broadcasting the network formation request to one or more targets; means for forming a network including at least one of the one or more targets; means for obtaining, from at least one of the one or more targets, event data associated with the event; and means for appending the event data associated with the event obtained from the one or more targets to a blockchain.

In some aspects, the apparatus is, includes, or is part of, a vehicle (e.g., an automobile, truck, etc., or a component or system of an automobile, truck, etc.) or a device or component of the vehicle, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure;

FIG. 2 is a diagram illustrating an example of a disaggregated base station architecture, which may be employed by the disclosed system for event-based network formation and event recording, in accordance with some aspects of the present disclosure;

FIG. 3 is a diagram illustrating an example of various user equipment (UEs) communicating over direct communication interfaces and wide area network interfaces, in accordance with some aspects of the present disclosure;

FIG. 4 is a block diagram illustrating an example of a computing system of a vehicle, in accordance with some aspects of the present disclosure;

FIG. 5 is a block diagram illustrating an example of a computing system of a user device, in accordance with some aspects of the present disclosure;

FIG. 6 is a flow chart illustrating an example event-based network and blockchain formation, in accordance with some aspects of the present disclosure;

FIG. 7 is a diagram illustrating an example of devices involved in wireless communications (e.g., sidelink communications), in accordance with some aspects of the present disclosure;

FIG. 8 is a diagram illustrating an example of a network formation scope, in accordance with some aspects of the present disclosure;

FIG. 9A is a block diagram illustrating three consecutive blocks of a blockchain ledger 900 that may be used to store data collected from devices participating in an event-based network, in accordance with some aspects of the present disclosure;

FIG. 9B is a block diagram illustrating an example distributed ledger, in accordance with some aspects of the present disclosure

FIG. 10 is a flow chart illustrating an example of a process for wireless communications, according to some aspects of the present disclosure;

FIG. 11 illustrates an example computing system, according to aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as Basic Safety Messages (BSMs) and Cooperative Awareness Messages (CAMs), which are application layer messages, are designed to be wirelessly broadcasted over the 802.11p based DSRC interface and the LTE C-V2X sidelink PC5 interface.

As previously mentioned, the V2X technology includes V2V communications, which can also be referred to as peer-to-peer communications. V2V communications allows for vehicles to directly wireless communicate with each other while on the road. With V2V communications, vehicles can gain situational awareness by receiving information regarding upcoming road dangers (e.g., unforeseen oncoming vehicles, accidents, and road conditions) from the other vehicles.

In a V2X communication system, information is transmitted from vehicle sensors (and other sources) through wireless links to allow the information to be communicated to other vehicles, pedestrians, VRUs, and/or traffic infrastructure. The information may be transmitted using one or more vehicle-based messages, such as cellular-vehicle-to-everything (C-V2X) messages, which can include Sensor Data Sharing Messages (SDSMs), BSMs, CAMs, Collective Perception Messages (CPMs), Decentralized Environmental Messages (DENMs), and/or other types of vehicle-based messages.

Solutions are needed for securely and privately collecting data in an impromptu manner based on detection of an event. Systems and techniques are described herein for utilizing a blockchain to fulfill the security and privacy requirements in an impromptu network formed and operated in an ad hoc manner among the peer participants without the presence of a central authority.

In one illustrative example, a traffic accident is an event that can benefit from data collection by an impromptu network. For example, data collected by parties witnessing a traffic accident event can be good information sources about the traffic accident. However, in some cases, event data captured by parties witnessing the accident may not be organized by any central authority. In some examples, a lack of a central entity can result in a lack of credibility and/or trust regarding the event data. In some aspects, collecting data from the parties in a blockchain can preserve the event data and/or prevent later modifications of event data. In some examples, a blockchain can provide a repository for event data captured by the different parties witnessing the traffic accident.

Although a traffic accident is provided as an example event for the purposes of illustration, it should be understood that the systems and techniques described herein can be used for data collection related to events that may or may not involve vehicles. Similarly, although data collection by electronic equipment included in a vehicle is described below, data collected from other types of electronic devices (e.g., handheld devices, wearable devices, sensors attached to stationary objects, or the like) can be used without departing from the scope of the present disclosure. In addition to vehicles directly involved in an accident, electronic in close physical proximity to the directly involved vehicles can contemporaneously collect data relevant to reconstructing the events that occur before, during, and after a traffic accident. For example, a vehicle in a nearby lane may collect images or video from one or more cameras, RADAR data, LIDAR data, audio data, or the like capturing the accident and events leading up to the accident.

In some cases, data collected from participants in the network can append data to a blockchain. The blockchain can provide security and privacy, as well as store the appended data in a sequence that can be used to reconstruct the event based on the collected data (also referred to as detailed event data herein). In some cases, rather than collecting the raw data collected by the devices participating in the network, the raw data can be hashed and stored in the blockchain. The hashed data (also referred to as hashed event data herein) related to the collected raw data can later be used to verify the authenticity of raw data collected from participants of the network. For example, a camera of a vehicle nearby to a traffic accident may capture a video of the accident. In some cases, the raw video data can be hashed and the hash can be appended to the blockchain. In some cases, the owner of the raw video data can choose whether or not to opt-in. Furthermore, the order of observations added to the blockchain can at least partially record and preserve the time sequence of observations, in addition to time stamps in the data.

In some cases, one or more electronic devices can initiate formation of a network based on occurrence of an event (e.g., a traffic accident). In one illustrative example, a stationary roadside device may initiate formation of the network based on detecting a traffic accident. In some cases, the network formation can be transmitted as a network formation request to one or more devices in the vicinity of the event and/or the initiating electronic devices. In one illustrative example, the network formation request transmission may be based on a dedicated short range communication (DSRC) based on 802.11p on the PHY/MAC and IEEE 1609.2/3/4 on the upper layers, or based on group-cast in Mode 2 in NR cellular V2X (NR C-V2X) or Mode 4 in LTE V2X. In some cases, the network participants can communicate with the network through different types of physical layer connections. In some cases, the physical layer connections can be provided by different service providers.

In some examples, devices receiving the network formation request can forward the request to other nearby devices. In some examples, the request forwarding can be limited by time, location, relevance and/or any combination thereof. In some cases, by limiting the network request formation forwarding, data stored in the blockchain can be highly specific and relevant to the event.

In some implementations, a responding device may broadcast the broadcast with appended data to multiple devices in the network. For example, participants in the network may not be directly connected with all other devices participating in the network. As a result of the broadcast to different devices and/or the differing connections between devices of the network, multiple branches or forks may exist in the process of appending data from the network participants. In one illustrative example, an initiator and/or another network participant can determine the appendix order. In some cases, the device that determines the appendix order can also be referred to as a controlling device. As used herein, the appendix order can refer to a specified order for network participants to append data to a chain. In some cases, the appendix order can prevent branches and/or forks. For example, a network participant may announce its central role to the network and responding nodes can acknowledge the message. In another illustrative example, a distributed method for managing branching and/or forking (also referred to herein as branch reduction and/or fork reduction) can be based on the length of the blockchain. In some cases, a participating device can append its data to the longest available chain at the time of appending data. In some cases, appending data to the longest available chain can reduce the number of branches and/or forks of the blockchain by preventing addition of data to multiple chains. In another illustrative examples, branches and forks can be allowed to form and the relationships between branches and/or forks can be stored and used to establish an organizational structure for the blockchain. In one illustrative example, relationships between branches and/or forks can be stored as a hashgraph. As used herein, a hashgraph is a distributed ledger system that can store data in multiple chains and generate an order for nodes based on a consensus for a timestamp of each transaction stored across the multiple chains.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

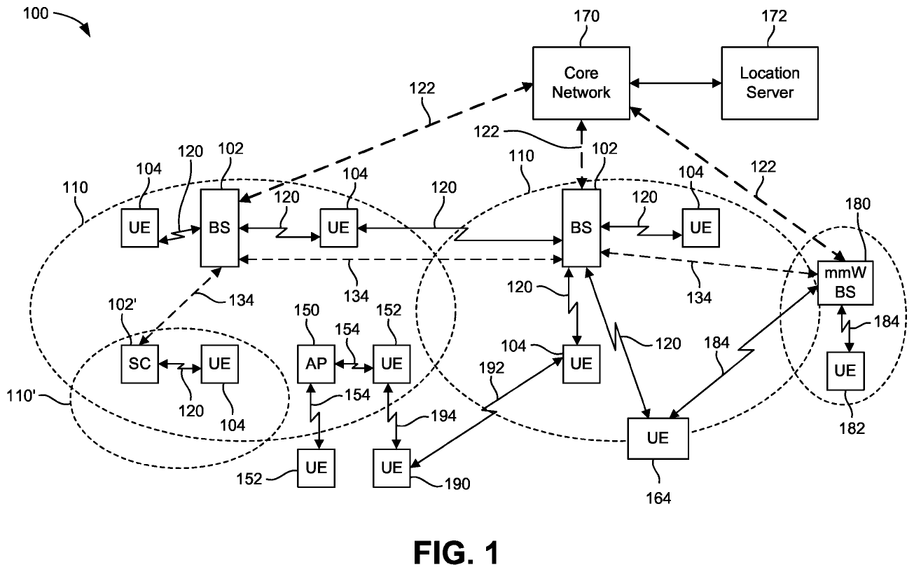

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or Multefire.

The wireless communications system 100 may further include a millimeter wave (mm W) base station 180 that may operate in mmW frequencies and/or near mm W frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR 1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHZ (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

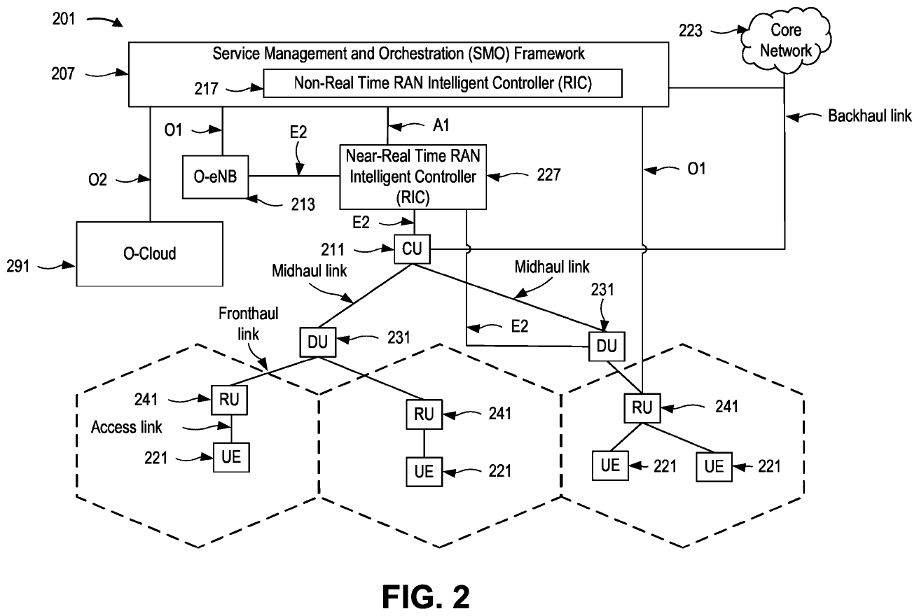

FIG. 2 is a diagram illustrating an example of a disaggregated base station architecture, which may be employed by the disclosed system for event-based network and blockchain formation, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUs) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit—User Plane (CU-UP)), control plane functionality (i.e., Central Unit—Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 231, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-eNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A2 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via O1) or via creation of RAN management policies (such as A1 policies).

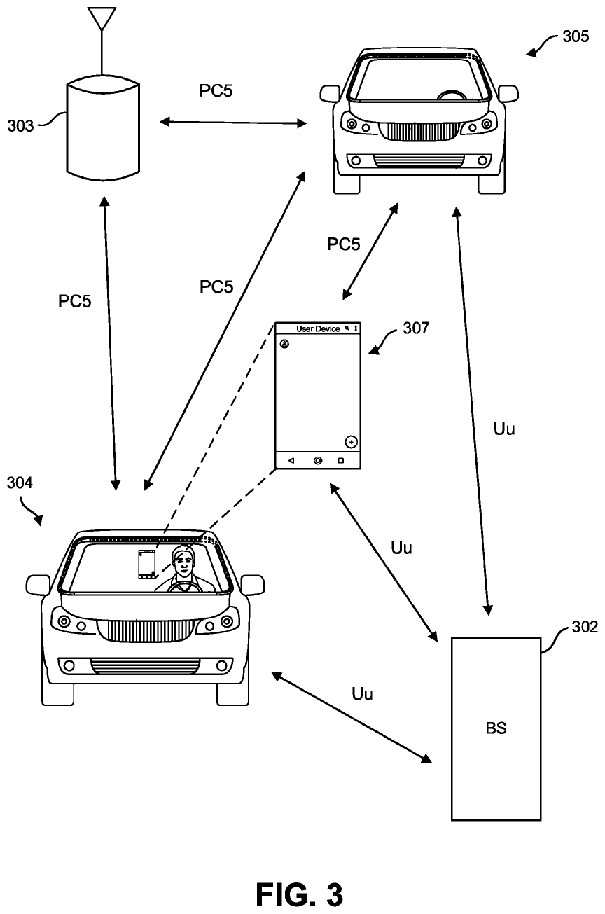

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 communicating with the base station 302 using a network (Uu) interface. As described below, functionalities can be transferred from a vehicle (e.g., vehicle 304) to a user device (e.g., user device 307) based on one or more characteristics or factors (e.g., temperature, humidity, etc.). In one illustrative example, V2X functionality can be transitioned from the vehicle 304 to the user device 307, after which the user device 307 can communicate with other vehicles (e.g., vehicle 305) over a PC5 interface (or other device to device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

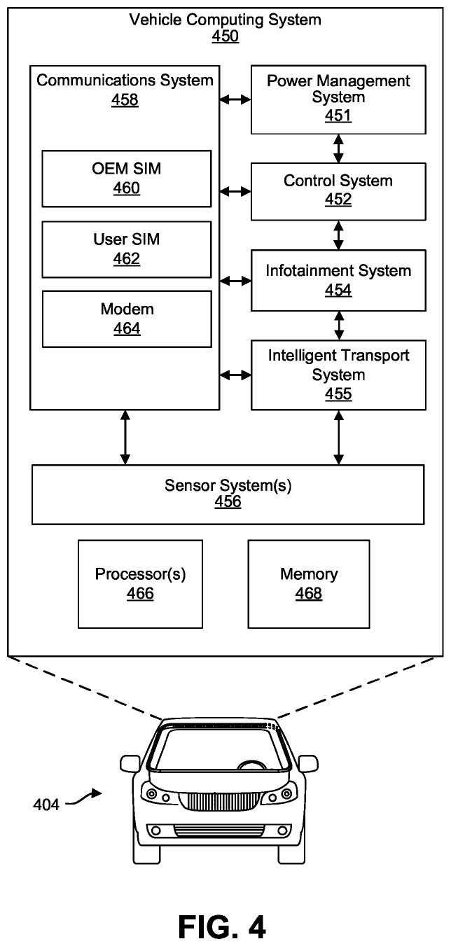

FIG. 4 is a block diagram illustrating an example a vehicle computing system 450 of a vehicle 404. The vehicle 404 is an example of a UE that can communicate with a network (e.g., an eNB, a gNB, a positioning beacon, a location measurement unit, and/or other network entity) over a Uu interface and with other UEs using V2X communications over a PC5 interface, a C-V2X interface, or other device to device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (eCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V2I communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 can determine a lane-change condition has been met that is associated with a message to be sent to other vehicles that are nearby the vehicle in the adjacent lane. The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

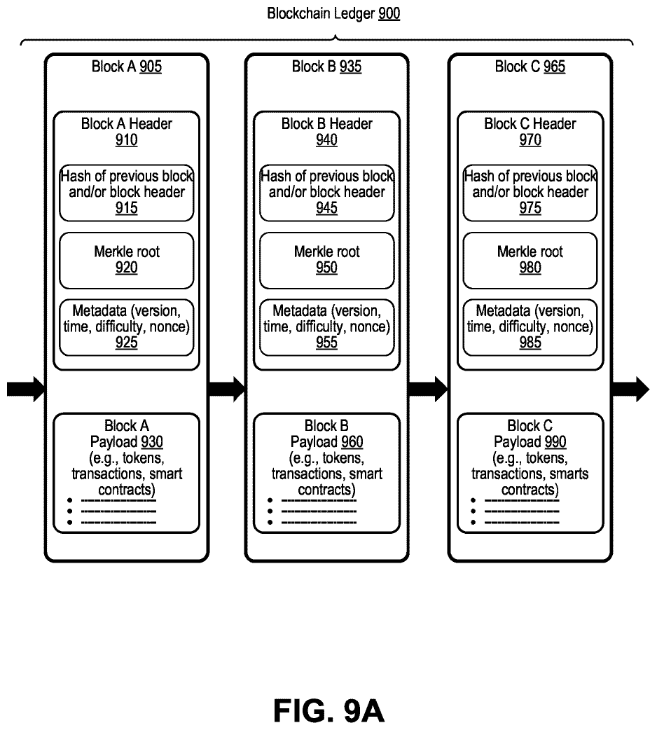

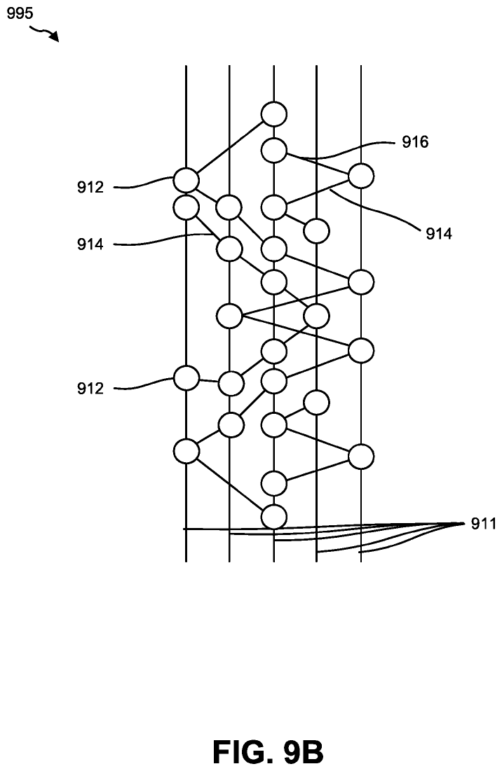

In some implementations, the vehicle computing system 450 can also include (e.g., as part of or separate from the control system 452, the infotainment system 454, the communications system 458, and/or the sensor system(s) 456) at least one processor 466 and at least one memory 468 having computer-executable instructions that are executed by the at least one processor. The at least one processor is in communication with and/or electrically connected to (referred to as being “coupled to” or “communicatively coupled”) the at least one memory. The at least one processor 466 can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein. In some cases, the at least one processor 466 can be configured to perform one or more operations associated with storing and/or retrieving data in a ledger based data storage (e.g., a blockchain). For example, the at least one processor 466 can be configured to perform one or more operations associated with a blockchain ledger 900 as described with respect to FIG. 9A below, a distributed ledger 995 as described with respect to FIG. 9B, other distributed ledgers, and/or any combination thereof. In some cases, the data for the ledger based data storage can be stored and/or retrieved from the at least one memory 468 of FIG. 4.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown).

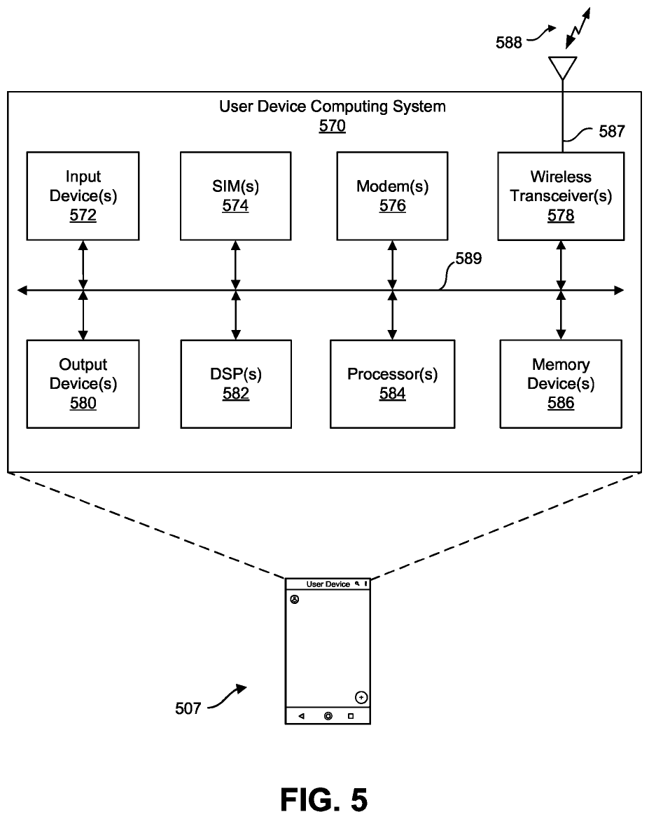

FIG. 5 illustrates an example of a computing system 570 of a user device 507. The user device 507 is an example of a UE that can be used by an end-user. For example, the user device 507 can include a mobile phone, router, tablet computer, laptop computer, tracking device, wearable device (e.g., a smart watch, glasses, an XR device, etc.), Internet of Things (IoT) device, and/or other device used by a user to communicate over a wireless communications network. The computing system 570 includes software and hardware components that can be electrically or communicatively coupled via a bus 589 (or may otherwise be in communication, as appropriate). For example, the computing system 570 includes one or more processors 584. The one or more processors 584 can include one or more CPUs, ASICs, FPGAs, APs, GPUs, VPUs, NSPs, microcontrollers, dedicated hardware, any combination thereof, and/or other processing device or system. The bus 589 can be used by the one or more processors 584 to communicate between cores and/or with the one or more memory devices 586.

The computing system 570 may also include one or more memory devices 586, one or more digital signal processors (DSPs) 582, one or more SIMs 574, one or more modems 576, one or more wireless transceivers 578, an antenna 587, one or more input devices 572 (e.g., a camera, a mouse, a keyboard, a touch sensitive screen, a touch pad, a keypad, a microphone, and/or the like), and one or more output devices 580 (e.g., a display, a speaker, a printer, and/or the like).

The one or more wireless transceivers 578 can receive wireless signals (e.g., signal 588) via antenna 587 from one or more other devices, such as other user devices, vehicles (e.g., vehicle 404 of FIG. 4 described above), network devices (e.g., base stations such as eNBs and/or gNBs, WiFI routers, etc.), cloud networks, and/or the like. In some examples, the computing system 570 can include multiple antennae. The wireless signal 588 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 578 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 588 into a baseband or intermediate frequency and can convert the RF signals to the digital domain.

In some cases, the computing system 570 can include a coding-decoding device (or CODEC) configured to encode and/or decode data transmitted and/or received using the one or more wireless transceivers 578. In some cases, the computing system 570 can include an encryption-decryption device or component configured to encrypt and/or decrypt data (e.g., according to the AES and/or DES standard) transmitted and/or received by the one or more wireless transceivers 578.

The one or more SIMs 574 can each securely store an IMSI number and related key assigned to the user of the user device 507. As noted above, the IMSI and key can be used to identify and authenticate the subscriber when accessing a network provided by a network service provider or operator associated with the one or more SIMs 574. The one or more modems 576 can modulate one or more signals to encode information for transmission using the one or more wireless transceivers 578. The one or more modems 576 can also demodulate signals received by the one or more wireless transceivers 578 in order to decode the transmitted information. In some examples, the one or more modems 576 can include a 4G (or LTE) modem, a 5G (or NR) modem, a modem configured for V2X communications, and/or other types of modems. The one or more modems 576 and the one or more wireless transceivers 578 can be used for communicating data for the one or more SIMs 574.

The computing system 570 can also include (and/or be in communication with) one or more non-transitory machine-readable storage media or storage devices (e.g., one or more memory devices 586), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In some cases, the one or more processors 584 can be configured to perform one or more operations associated with storing and/or retrieving data in a ledger based data storage (e.g., a blockchain). For example, the one or more processors 584 can be configured to perform one or more operations associated with a blockchain ledger 900 as described with respect to FIG. 9A, a distributed ledger 995 as described with respect to FIG. 9B, other distributed ledgers, and/or any combination thereof. In some cases, data for the ledger based data storage can be stored and/or retrieved from the one or more memory devices 586 of FIG. 5.

In various aspects, functions may be stored as one or more computer-program products (e.g., instructions or code) in memory device(s) 586 and executed by the one or more processor(s) 584 and/or the one or more DSPs 582. The computing system 570 can also include software elements (e.g., located within the one or more memory devices 586), including, for example, an operating system, device drivers, executable libraries, and/or other code, such as one or more application programs, which may comprise computer programs implementing the functions provided by various aspects, and/or may be designed to implement methods and/or configure systems, as described herein.

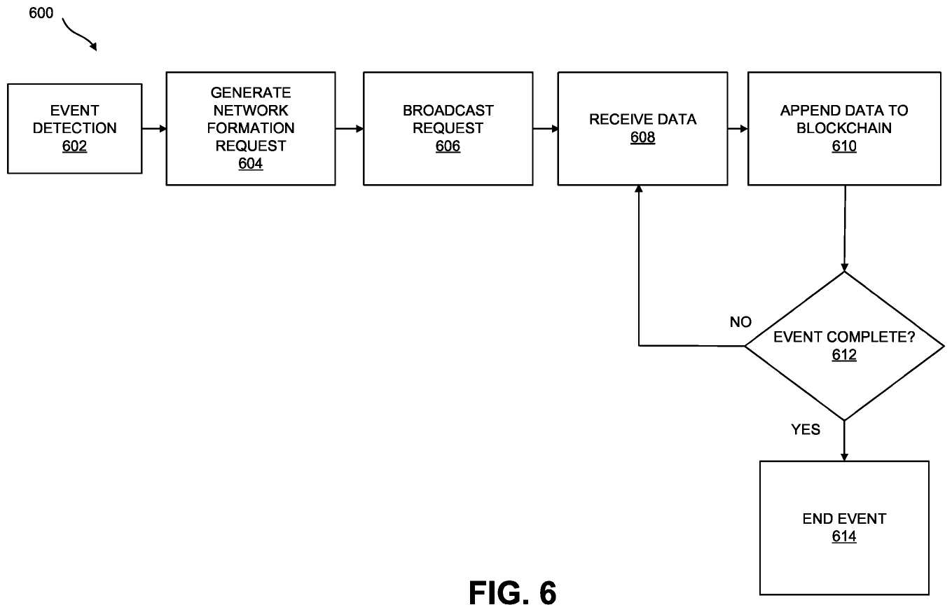

FIG. 6 is a flow diagram of a process 600 illustrating an example process for event-based network and blockchain formation. At block 602, the process 600 can include detection of an event. As used herein, an event can refer to any occurrence that, when detected, causes one or more electronic devices to initiate network and blockchain formation. For example, an event can be detected based on data collected by one or more devices such as RSU 303, vehicle 304, vehicle 305, user device 307, of FIG. 3, vehicle computing system 450 of FIG. 4, computing system 570 of FIG. 5, any other data associated with the event, and/or any combination thereof. In one illustrative example, an event can include potential danger indicated by data collected from one or more devices.

In one illustrative example, a traffic accident is an event that can benefit from data collection by an impromptu network. For example, a traffic accident can include any type of vehicle collision or near collision, such as with another vehicle, pedestrian, animal, road debris, or other stationary obstruction. Although a traffic accident is provided as an example event for the purposes of illustration, it should be understood that the systems and techniques described herein can be used for data collection related to events that may or may not involve vehicles.

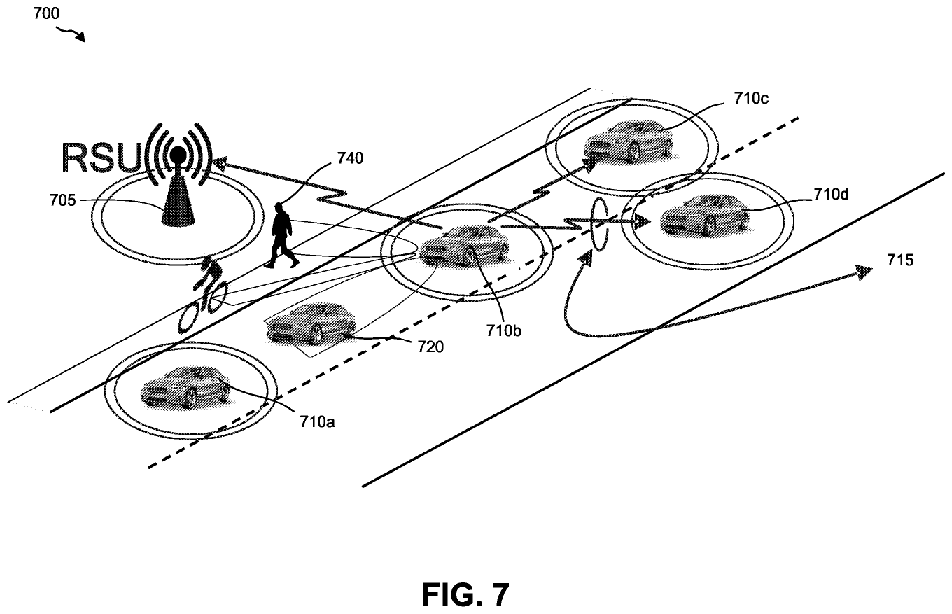

FIG. 7 is a diagram illustrating an example of a system 700 that can utilize event-based network and/or blockchain formation, in accordance with some examples of the present disclosure. In FIG. 7, the system 700 is shown to include a plurality of equipped (e.g., V2X capable) network devices. The plurality of equipped network devices includes vehicles (e.g., automobiles) 710a, 710b, 710c, 710d, and an RSU 705. Also shown are a plurality of non-equipped network devices, which include a non-equipped vehicle 720, a VRU (e.g., a bicyclist) 730, and a pedestrian 740. The system 700 may comprise more or less equipped network devices and/or more or less non-equipped network devices, than as shown in FIG. 7. In addition, the system 700 may comprise more or less different types of equipped network devices (e.g., which may include equipped UEs) and/or more or less different types of non-equipped network devices (e.g., which may include non-equipped UEs) than as shown in FIG. 7. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In one or more examples, vehicles 710a, 710b, 710c, 710d and RSU 705 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 700. For example, vehicle 710b may be a luxury vehicle and, as such, have more expensive, higher capability sensors than other vehicles that are economy vehicles. In one illustrative example, vehicle 710b may have one or more higher capability LIDAR sensors (e.g., high capability optical lasers and optical sensors) than the other equipped network devices in the system 700. In one illustrative example, a LIDAR of vehicle 710b may be able to detect a VRU (e.g., cyclist) 730 and/or a pedestrian 740 with a large degree of confidence (e.g., a seventy percent degree of confidence). In another example, vehicle 710b may have higher capability radar (e.g., high capability RF antennas) than the other equipped network devices in the system 700. For instance, the radar of vehicle 710b may be able to detect the VRU (e.g., cyclist) 730 and/or pedestrian 740 with a degree of confidence (e.g., an eight-five percent degree of confidence). In another example, vehicle 710b may have higher capability camera (e.g., with higher resolution capabilities, higher frame rate capabilities, better lens, etc.) than the other equipped network devices in the system 700.

During operation of the system 700, the equipped network devices (e.g., RSU 705 and/or at least one of the vehicles 710a, 710b, 710c, 710d) may transmit and/or receive sensing signals (e.g., RF and/or optical signals) to sense and detect vehicles (e.g., vehicles 710a, 710b, 710c, 710d, and 720) and/or objects (e.g., VRU 730 and pedestrian 740) located within and surrounding the road. The equipped network devices (e.g., RSU 705 and/or at least one of the vehicles 710a, 710b, 710c, 710d) may then use the sensing signals to determine characteristics (e.g., motion, dimensions, type, heading, and speed) of the detected vehicles and/or objects. The equipped network devices (e.g., RSU 705 and/or at least one of the vehicles 710a, 710b, 710c, 710d) may generate at least one vehicle-based message 715 (e.g., a V2X message, such as a SDSM, a BSM, a CAM, a CPM, and/or other type of message) including information related to the determined characteristics of the detected vehicles and/or objects.

The vehicle-based message 715 may include information related to the detected vehicle or object (e.g., a position of the vehicle or object, an accuracy of the position, a speed of the vehicle or object, a direction in which the vehicle or object is traveling, and/or other information related to the vehicle or object), traffic conditions (e.g., low speed and/or dense traffic, high speed traffic, information related to an accident, etc.), weather conditions (e.g., rain, snow, etc.), message type (e.g., an emergency message, a non-emergency or “regular” message), etc.), road topology (line-of-sight (LOS) or non-LOS (NLOS), etc.), any combination, thereof, and/or other information. In some examples, the vehicle-based message 715 may also include information regarding the equipped network device's preference to receive vehicle-based messages from other certain equipped network devices. In some cases, the vehicle-based message 715 may include the current capabilities of the equipped network device (e.g., vehicles 710a, 710b, 710c, 710d), such as the equipped network device's sensing capabilities (which can affect the equipped network device's accuracy in sensing vehicles and/or objects), processing capabilities, the equipped network device's thermal status (which can affect the vehicle's ability to process data), and the equipped network device's state of health.

In some aspects, the vehicle-based message 715 may include a dynamic neighbor list (also referred to as a Local Dynamic Map (LDM) or a dynamic surrounding map) for each of the equipped network devices (e.g., vehicles 710a, 710b, 710c, 710d and RSU 705). For example, each dynamic neighbor list can include a listing of all vehicles and/or objects that are located within a specific predetermined distance (or radius of distance) away from a corresponding equipped network device. In some cases, each dynamic neighbor list includes a mapping, which may include roads and terrain topology, of all of the vehicles and/or objects that are located within a specific predetermined distance (or radius of distance) away from a corresponding equipped network device. For example, a predetermined distance can include, without limitation, up to one hundred (100) yards, up to one thousand yards (1000), up to one mile, and/or any other predetermined distance. In one illustrative example, a distance (or radius of distance) between equipped network devices and/or objects can be determined based on position information for equipped network devices and/or objects included in vehicle-based messages 715 and a current position of an equipped network device generating the dynamic neighbor list.

Returning to FIG. 6, in one illustrative example, at block 602, the process 600 may determine that a vehicular accident is likely to occur based on sensing signals, sensor data (e.g., video data, LIDAR data, RADAR data, or the like) and/or content of the at least one vehicle-based message 715 that an event (e.g., a vehicular accident) is likely to occur and/or has already occurred.

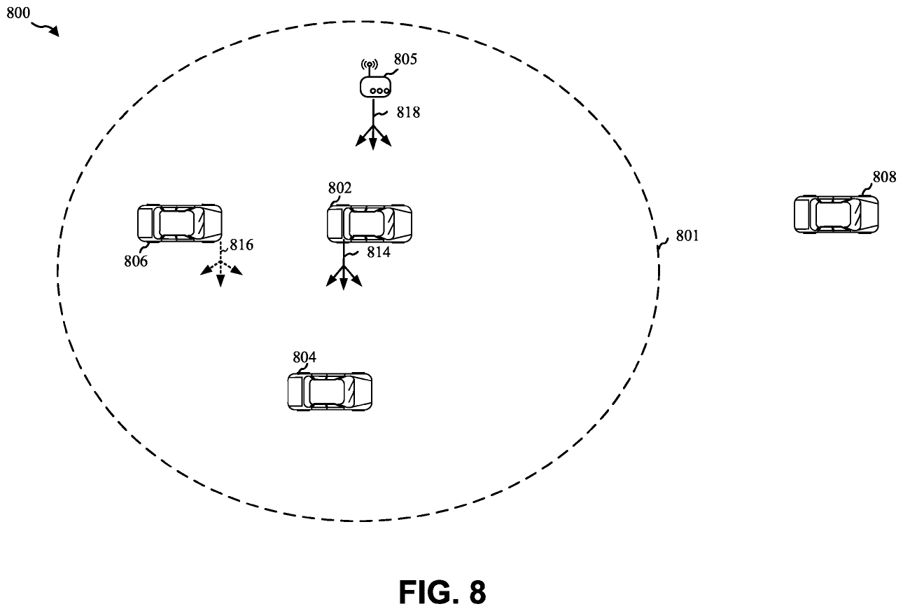

At block 604, after detecting the event, the process 600 can generate a network formation request. In some cases, the network formation request can be broadcast to devices in a predefined area associated with the detected event. In some cases, initiating the network formation request can include generating an event identifier (ID). In some cases, initiating the network formation request can include determining a scope for the network. For example, the scope for the network can include a network formation location. In one illustrative example, the location can be limited to a specified distance from the event. In another illustrative example, the location can be limited to the range of communication signal capabilities of the initiating device. In some case, the network formation request can include a time stamp of the event, a timestamp of the network formation request initiation, other timestamps related to the event, and/or any combination thereof. In some cases, the network formation request can include communications protocol capability of an initiating device (e.g., RSU 303, vehicle 304, vehicle 305, user device 307, of FIG. 3, vehicle computing system 450 of FIG. 4, computing system 570 of FIG. 5, vehicles 710a, 710b, 710c, 710d, of FIG. 7, UE 802, 804, 806 or RSU 805 of FIG. 8). In some cases, devices receiving the network formation request can determine whether to participate in event-based network formation and/or blockchain based on the network formation request.

At block 606, the process 600 can include broadcasting the network formation request. For example, the process 600 can broadcast the network formation request to multiple devices. As used herein, any device participating in an event-based network can be referred to as a “target” device. In one illustrative example, the transmission may be based on DSRC, NR C-V2X, mode 4 in LTE V2X, any other communication protocol, and/or any combination thereof.

FIG. 8 illustrates an example of an event-based network configuration 800, in accordance with some aspects of the present disclosure. In some cases, a network formation scope of FIG. 8 can be determined during the generation of a network formation request at block 604 of the process 600. As illustrated in FIG. 8, the network formation scope can include a location 801 for the network formation. In one illustrative example, the UE 802 may generate the network formation request. As shown in FIG. 8, the UE 802 may broadcast 814 a network formation request. As illustrated, the UE 808 may be outside of the location 801. In some cases, the UE 808 can be excluded from the network formation request. In some cases, the network formation request may be received by receiving UEs 804, 806, 808. Although UEs 802, 804, 806, and 808 are illustrated as vehicles in FIG. 8, the network formation request can be broadcast by the initiating device (e.g., UE 802) to other UEs such as mobile devices, sensors, or the like. In some cases, the network broadcast 814 may be broadcast or multicast to nearby devices. In some cases, the devices participating in the network may not share common communication capabilities. For example, the UE 806 For example, UE 806 may transmit 816 communication intended for receipt by other UEs within a the location 801 specified in the network formation request. Additionally/alternatively, RSU 805 may receive communication from and/or broadcast 818 to UEs 802, 804, 806, 808. UE 802, 804, 806, 808 or RSU 805. In some cases, the RSU 805 may initiate network formation and/or broadcast 818 the network formation request. In some cases, another UE (not shown) in the vicinity of the event can initiate the network formation and/or broadcast the network formation request.

Returning to FIG. 6, at block 608, the process 600 can receive event data from one or more devices participating in the event-based network (e.g., RSU 303, vehicle 304, vehicle 305, user device 307, of FIG. 3, vehicle computing system 450 of FIG. 4, computing system 570 of FIG. 5, vehicles 710a, 710b, 710c, 710d, of FIG. 7, UE 802, 804, 806 or RSU 805 of FIG. 8). In some cases, the received data can include at least one or more of data captured by input devices (e.g., input devices 572 of FIG. 5) such as video data, audio data, or the like. In some examples, the received data can include sensor data (e.g., from one or more sensor systems 456). In some cases, the data received from the network participants can include vehicle data logs (e.g., data related to acceleration, braking, turning, and/or distance keeping). In some aspects, the data can include RADAR data, LIDAR data, or the like.

In some implementations the data received from the one or more devices participating in the event-based network can include the data collected by the one or more devices (e.g., sensor data, video data, audio data, etc.). In some examples, the data received from the one or more devices can include a hash of the data collected by the one or more devices. In some cases, the captured data can remain on the participating device. In some cases, if a need for the original data (e.g., the captured data itself) arises, the hash can be used to verify the authenticity of the data being provided by the owner of the captured data. In some cases, providing a hash of captured data rather than the data itself can provide privacy for owners of devices participating in the network. For example, if the collected data from a video camera of a UE does not capture an event (e.g., the vehicle accident), but instead of a video of passengers, scenery, or the like, the hashed data may not reveal the content of the video. In some cases, the owners of the collected data can opt-in to sharing the collected data if needed. For example, in the case of a vehicle accident, the collected data may be requested as evidence in a legal proceeding. In such cases, the hashed data can be used to authenticate the timing and/or location that the data was collected, without requiring the collected data to be directly stored. In addition to providing privacy benefits, the hashed data can also be smaller in data size than the collected data. In some cases, hashed data can have a fixed sized (e.g., 128 bytes, 256 bytes, 512 bytes, 1024 bytes) that does not depend on the size of the collected data. For example, a video recording of several hundred megabytes (MB) could be represented by hashed data of 1 kilobyte (KB). As a result, the amount of communication bandwidth required to collect the event-based data can be limited. In some examples, the total amount of storage required to collect the event-based data can also be reduced by storing the hashed data instead of the collected data itself.

Returning to FIG. 6, at block 610, the process 600 can append collected data to a blockchain. In some cases, the blockchain can be shared and mutually stored by participating devices in the event-based network. In some cases, a centralized blockchain server may not be required to store the blockchain. In some aspects, a blockchain is well suited to event-based data collection because of its ability to build trust in a decentralized, distributed, and autonomous way. As used herein, a blockchain includes any distributed database with electronic transactions and/or events stored in a ledger and shared among participating members of the blockchain. The process 600 can, in turn, share the blockchain with the newly appended data with the devices participating in the event-based network.

FIG. 9A is a block diagram illustrating three consecutive blocks of an example blockchain ledger 900 that may be used to store data collected from devices participating in an event-based network, according to an aspect of the present disclosure. Three blocks of the example blockchain ledger 900 are illustrated in FIG. 9A, including Block A 905, Block B 935, and Block C 965.

Each block includes a block header 910/940/970 and a list of one or more payloads 930/960/990. In some examples, block header 910/940/970 includes a hash 915/945/975 of the previous block and/or a hash 910/940/970 of the block header of the previous block, collectively referred to herein as a “block hash.” For instance, the header 970 of block C 965 includes a hash 975 of the header 940 of block B 935. The header 940 of block B 935 likewise includes a hash 945 of the header 910 of block A 905. The header 910 of block A 905 likewise includes a hash 915 of a header (not pictured) of previous block (not pictured) that is before block A 905 in the blockchain ledger 900. Including the hash of the previous block's header secures the blockchain ledger 900 by preventing modification of any block of the blockchain ledger 900 after the block has been entered into the blockchain ledger 900, as any change to a particular block would cause that block header's hash 915/945/975 in the next block to be incorrect. Further, modification of that block header's hash in the next block would make the next block's header's hash 915/945/975 in the block after the next block incorrect, and so forth. A verifying device can verify that a block has not been modified by computing the hash of block and/or of the block header, then comparing the computed hash to the stored hash 915/945/975 that is stored in the next block. In some distributed ledgers, a block header 910/940/970 can include hashes of multiple previous blocks and/or hashes of block headers of multiple previous blocks, as in the distributed acyclic graph (DAG) ledger.

Each block's block header 910/940/970 can include a Merkle root 920/950/980. The Merkle root 920/950/980 can be generated based on hashes of each of the event data (e.g., collected data and/or hashed data), transactions, smart contracts, and/or other elements identified in the payload 930/960/990 for that block. Any attempt to modify a payload after the block has been entered would change the Merkle root. A verifying device can verify that the payload(s) 930/960/990 have not been modified by computing the Merkle root, then comparing the computed Merkle root to the stored Merkle root 920/950/980 that is stored in the block header 910/940/970. Changes to the payload 930/960/990 and/or to the Merkle root 920/950/980 would also change the hash for the block and/or for the block header, for which a value is stored in the next block as the hash 915/945/975. Each payload of each block may include one or more event data, tokens, one or more transactions, one or more smart contracts, other content, or combinations thereof.

Each block's block header 910/940/970 may also include various elements of metadata, such as a version number for the blockchain ledger platform, a version number for the block itself, a timestamp for verification of each payload, a timestamp for generation of the block, a timestamp for entry of the block into the blockchain ledger 900, a timestamp for request of generation of the block, a difficulty target value (e.g., adjusting difficulty of mining), one or more randomized nonce values, a counter identifying how many nonces have been tried, a title of the blockchain ledger 900, an identifier as to what the blockchain ledger 900 is tracking (e.g., a history of data associated with a triggering event), or a combination thereof. Each individual element added can further serve as information that can be verified by a verifying device to identify if the block, and the payload within, is accurate and authorized. The one or more randomized nonce values can serve to further complicate the hashes, improving security.

Each block 905/935/965 of the blockchain ledger 900 also includes a payload 930/960/990. The payload 930/960/990 for each block 905/935/965 can include one or more event data (e.g., collected data and/or hashed data), one or more tokens, one or more transactions, one or more smart contracts, one or more other elements, metadata related to any of the previously-listed elements, or combinations thereof. In some cases, certain parts of the payload (e.g., event data) can be stored within the payload 930/960/990 of the blockchain ledger 900, and are thus stored “on-chain.” In some cases, certain parts of the payload (e.g., event data) can include on-chain pointers that point to data outside of the blockchain ledger 900, with such data being stored “off-chain.” The payload 930/960/990 of the blockchain ledger 900 may store hashes of off-chain data, so that a verifying device can compute a hash of the off-chain data and compare the computed hash to the stored hash that is stored on-chain to verify that the off-chain data is accurate.

In one illustrative example, a first computing device can store a blockchain ledger including a plurality of blocks. Each of a plurality of computing devices (e.g., in a distributed architecture) also stores a copy of the blockchain ledger. The first computing device can receive a message identifying an intended payload element (e.g., event data). For example, the intended payload element may be collected data (e.g., sensor data, video, audio, or the like) and/or hashed data associated with the collected video data. The first computing device can verify that the intended payload element is valid.

The first computing device can generate a hash of a most recent block or block header of the blockchain ledger 900. The first computing device can generate a new block header for a new block. The new block header can include at least the hash of the most recent block or block header of the blockchain ledger 900. The first computing device can generate the new block, the new block including the new block header and a payload with one or more payload elements. The one or more payload elements include at least the intended payload element discussed above (e.g., event data). The first computing device can generate a Merkle root based on the payload elements, and include the Merkle root in the new block header. The first computing device can generate a metadata and a nonce value based on the payload elements, and include the metadata and the nonce value in the new block header. The first computing device can append the new block to the plurality of blocks of the blockchain ledger 900 in response to verifying the intended payload element. The first computing device can transmit the new block to the plurality of computing devices that each store the blockchain ledger 900 in response to verifying the intended payload element. Each of the plurality of computing devices also appends the new block to their respective copy of the blockchain ledger 900.

In another illustrative example, a first computing device can store a blockchain ledger 900 including a plurality of blocks. Each of a plurality of computing devices (e.g., in a distributed architecture) also stores a copy of the blockchain ledger 900. The first computing device can receive a UI input identifying an intended payload element (e.g., event data). The first computing device can generate a message identifying the intended payload element. The first computing device can retrieve a private key associated with an account corresponding to the first computing device. The first computing device can modify the message by encrypting at least a portion of the message with the private key. The first computing device can transmit the message to the plurality of computing devices other than the first computing device (e.g., other participants in the event-based network). A second computing device of the plurality of computing devices verifies that the intended payload element is valid, for instance as described in the previous paragraph. The first computing device receives a new block from the second computing device. The new block identifies and/or includes the intended payload element (e.g., in its payload). The first computing device appends the new block to the plurality of blocks of the blockchain ledger 900 at the first computing device.

While FIG. 9A only illustrates three blocks 905/935/965 of the blockchain ledger 900, it should be understood that any blockchain ledger or distributed ledger discussed herein may be longer or shorter, and may have more than three blocks or fewer than three blocks.

FIG. 9B is a block diagram illustrating an example distributed ledger 995. In the example distributed ledger 995, the blocks 912 of the blockchain ledger can be stored in multiple parallel blockchains 911. In the illustrated example, rather than pruning forked blockchains, the payload (e.g., payload 930/960/990) of each block 912 can include a first pointer 914 to a most recently received block. In addition, the payload (e.g., payload 930/960/990) can include a second point to a most recently sent block. Using the first point 914 and second pointer 916, the distributed ledger 995 can maintain an accurate accounting and ordering of blocks appended to the distributed ledger 995 despite the individual blocks being included in separate individual blockchains 911. In some cases, such a distributed ledger can robustly store event data received from multiple participating event-based network devices. As used herein, the pointers 914, 916 can be referred to as “block pointers.”

In some cases, it can be desirable for instances of the blockchain stored on different devices (e.g., participants of the event-based network) to be identical. However, in some cases, participating devices may transmit and/or receive data from different network participants at different times. In some cases, the differing instances of a blockchain can be referred to as branches and/or forks. In some implementations, branches and/or forks can be pruned (e.g., deleted, abandoned, or the like).

Returning to FIG. 6, in one illustrative example, at block 610, the process 600 can determine the order of appending data to the blockchain ledger. In some cases, the process 600 can broadcast a message to participating network devices of its central role. In some implementations, if the devices participating in the event-based network acknowledge the message, the process 600 can broadcast an appendix order to the participating devices.

In another illustrative example, the process 600 can append data to a blockchain based on certain conditions. For example, the process 600 may append data to a blockchain only if the blockchain does not already include collected data (and/or associated hashed data) collected by the initiating device. In some cases, the process 600 can determine whether to append collected data to the chain based on a length of the chain. For example, a length of the chain may be included in a payload (e.g., payload 930, 960, 980 of FIG. 9A). In some cases, each participating device in the event-based network can each add data to the blockchain only one time. In some cases, participating devices can append data to the blockchain sequentially in multiple rounds of appending data to the blockchain. For example, in some cases, the initiating device (or another device agreed upon by participants of the blockchain) can establish an appendix order specifying an order in which each participating of the blockchain is permitted to the blockchain. In some cases, a first device in the appendix order can be permitted to add data to the blockchain during a first round, a second device in the appendix order can be permitted to add data to the blockchain during a second round, and each subsequent device in the appendix order can append data to the blockchain according to the appendix order until data from each participant has been appended to the blockchain.

Returning to FIG. 6, at block 612, the process 600 can determine whether the event has completed. For example, criteria for determining that the event has been completed can include, without limitation, an amount of time since the occurrence of the event, an amount of event data (hashed data and/or collected data) stored in the blockchain, sensor data indicating that the event is complete, or the like. In some cases, an amount of time can include, without limitation, 5 minutes, 15 minutes, 30 minutes, or any other fixed amount of time. In some cases, an amount of time can be determined based on the type of event. For example, the end of a vehicle accident event may be determined by typical response time of an emergency services vehicle. In some cases, an event may have a scheduled duration (e.g., a social event, a concert, or any other scheduled event) a time indicating completion of the event may be determined by a scheduled end time of the event. In some cases, the process 600 can determine that the event is completed based on data received from one or more of the devices participating in the event-based network. In some cases, the process 600 can determine that the event is completed based on the length of the blockchain. For example, the process 600 can determine that the event is completed when the blockchain includes 100, 1000, 10,000, or any other number of event data, 100, 1000, 10,000, or any other number of blocks, 100, 1000, 10,000, or any other number of MB of data, and/or any other measure of length of the blockchain. For example, one or more of the devices may broadcast an end event request. In some cases, the process 600 can determine whether the end event request is appropriate (e.g., to prevent premature termination of the event-based network and blockchain). In some cases, if the process 600 determines that the event has not completed, the process 600 can return to block 608.

In some cases, at block 614 if the process 600 determines that the event has completed, the process 600 can end event data collection. For example, the process 600 can treat the content of the event data store in the event-based blockchain to be complete and discontinue adding data to the event-based blockchain. In some cases, the process 600 can broadcast an end event request to other devices participating in the event-based network. In some cases, the process 600 can discontinue communication with the one or more target devices participating in the event-based network.

In some cases, after event has concluded and the blockchain is finalized, the data may later be retrieved. In some cases, if only hashed data is stored in the blockchain, any entity (e.g., the initiating device, law enforcement, a court, or any other entity), may contact the participating devices for the captured data. In some cases, the captured data from the participating devices can be verified using the hash stored in the blockchain. In some cases, the blockchain contents can also be compared across multiple participants in the event-based network.

Systems and techniques are described herein for event-based network and/or blockchain formation. In some cases, the network can be formed between devices near the location of the event at the time the event occurs. A distributed ledger based storage (e.g., a blockchain) can be used to build trust among the participating members of the event-based network. Participating members of the event-based network may not be able to directly communicate with every member of the event-based network, but the event data can still be distributed to all participating members as long as there is an indirect path for communication between the devices. The information stored in the blockchain can provide a sequential representation of the event, which can later be used as evidence of the event's occurrence. Privacy of the participating members of the event-based network can be provided by storing hashed data on the blockchain while the collected data is stored off-chain. The collected data can later be retrieved from one or more participating devices and the hash can be used to verify the authenticity of the retrieved data. For example, the retrieved data can be hashed and the resulting hash can be compared to the hashed data in the ledger. In some cases, if the resulting hashed data matches the hashed data stored in the blockchain, the authenticity of the retrieved data can be verified. In some cases, a timestamp of entry of the hashed data to the blockchain can be used to connect the retrieved data to an event (e.g., if the timestamp matches the time of the event).

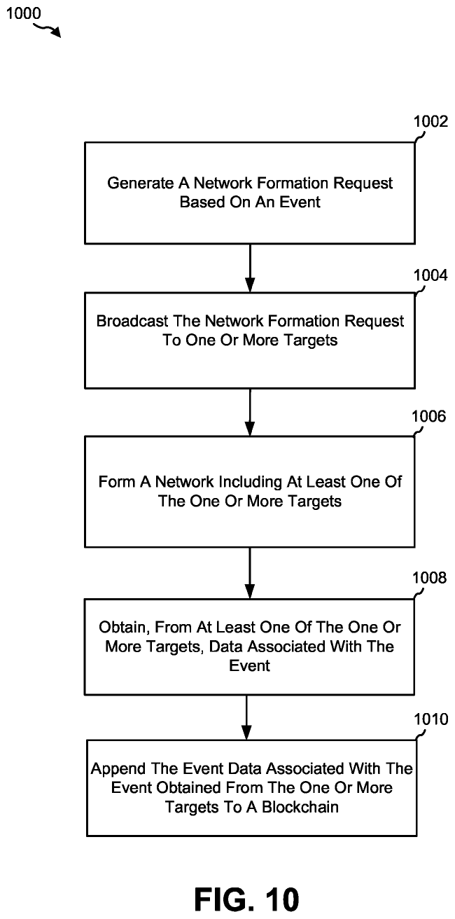

FIG. 10 is a flow chart illustrating an example of a process 1000 for recording event data. At block 1002, the process 1000 includes generating a network formation request (e.g., by UE 802) based on an event. In some cases, generating the network formation request includes generating an event identifier (ID). In some examples the event ID includes at least one or more of an event code, an event location, or an event time stamp.

At block 1004, the process 1000 includes broadcasting the network formation request to one or more targets (e. g,. UEs 804, 806, RSU 805). In some examples, initiating the network formation request includes detecting the event by at least one or more of a roadside unit, a vehicle, or a mobile device.

At block 1006, the process 1000 includes forming a network including at least one of the one or more targets. In some examples, the network includes a V2X network and the event data associated with the event includes at least one or more of: vehicle data logs. In some examples, the vehicle data logs include data related to at least one or more of acceleration, braking, turning, or distance keeping; video data; audio data; RADAR data; or LIDAR data. In some cases, forming the network includes receiving, from at least one or the one or more targets, a reply to the network formation request. In some examples, the process 1000 includes, based on receiving the reply to the network formation request, establishing a communications link with at least one of the one or more targets.

At block 1008, the process 1000 includes obtaining, from at least one of the one or more targets, event data associated with the event. In some examples, the event data associated with the event includes hashed event data corresponding to detailed event data collected from at least one of the one or more targets. In some aspects, the hashed event data can be used to verify the detailed event data.

At block 1010, the process 1000 includes appending the event data (e.g., in a payload 930, 960, 990) associated with the event obtained from the one or more targets to a blockchain (e. g,. Blockchain ledger 900, distributed ledger 995). In some implementations, the blockchain includes a plurality of blocks (e.g., block A 905, block B 935, block C 965, blocks 912) each block including at least a block hash (e.g., hash 915, hash 945, hash 975) and a payload (e.g., payload 930, payload 960, payload 990). In some examples, each block includes at least one block pointer (e.g., first pointer 914, second pointer 916). In some examples, a block of the plurality of blocks includes hashed event data (e.g., included in a payload of a block) corresponding to detailed event data. In some cases, a data size associated with the hashed event data is less than a data size associated with the detailed event data. In some examples, the detailed event data is stored outside of the blockchain (e.g., stored by vehicles 710a, 710, 710c, 710d, UEs 804, 806, RSU 805, and/or other devices).

In some cases, the process 1000 includes ending the blockchain based on at least one or more of an amount of time or a blockchain length. In some examples, ending the blockchain includes broadcasting an end event request.

In some implementations, the process 1000 includes receiving a first reply to the network formation request from a first target of the one or more targets over a first physical layer connection and receiving a second reply to the network formation request from a second target of the one or more targets over a second physical layer connection. In some cases, the first physical layer connection and the second physical layer connection utilize different communication protocols.

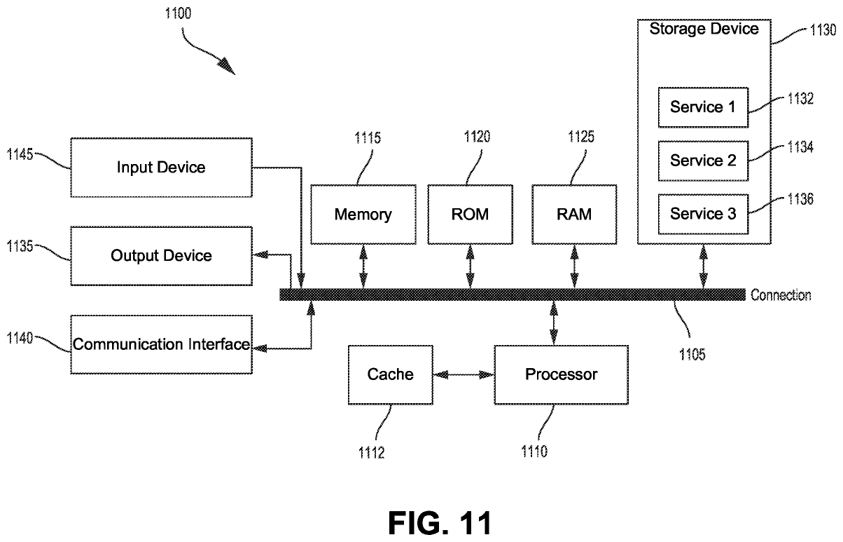

FIG. 11 is a block diagram illustrating an example of a computing system 1100, which may be employed by the disclosed system for smart vehicle malfunction and driver misbehavior detection and alert, in accordance with some aspects of the present disclosure. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., LIDAR sensors, laser range finders, RF radars, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1(L1 ) cache, Level 2(L2 ) cache, Level 3(L3 ) cache, Level 4(L4 ) cache, Level 5(L5 ) cache, or other (L#) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:
Aspect 1. A method for recording event data comprising: generating a network formation request based on an event; broadcasting the network formation request to one or more targets; forming a network including at least one of the one or more targets; obtaining, from at least one of the one or more targets, event data associated with the event; and appending the event data associated with the event obtained from the one or more targets to a blockchain.
Aspect 2. The method of Aspect 1, wherein generating the network formation request comprises generating an event identifier (ID), wherein the event ID comprises at least one or more of an event code, an event location, or an event time stamp.
Aspect 3. The method of any of Aspects 1 to 2, further comprising ending the blockchain based on at least one or more of an amount of time or a blockchain length.
Aspect 4. The method of Aspect 3, wherein ending the blockchain comprises broadcasting an end event request.
Aspect 5. The method of any of Aspects 1 to 4, wherein the event data associated with the event comprises hashed event data corresponding to detailed event data collected from at least one of the one or more targets, wherein the hashed event data can be used to verify the detailed event data.
Aspect 6. The method of any of Aspects 1 to 5, wherein the blockchain comprises a plurality of blocks, each block including at least a block hash and a payload.
Aspect 7. The method of Aspect 6, wherein each block includes at least one block pointer.
Aspect 8. The method of Aspect 6, wherein a block of the plurality of blocks includes hashed event data corresponding to detailed event data, wherein a data size associated with the hashed event data is less than a data size associated with the detailed event data.
Aspect 9. The method of Aspect 8, wherein the detailed event data is stored outside of the blockchain.
Aspect 10. The method of any of Aspects 1 to 9, wherein initiating the network formation request includes detecting the event by at least one or more of a roadside unit, a vehicle, or a mobile device.
Aspect 11. The method of any of Aspects 1 to 10, wherein the network includes a vehicle-to-everything (V2X) network and the event data associated with the event comprises at least one or more of: vehicle data logs, wherein the vehicle data logs include data related to at least one or more of acceleration, braking, turning, or distance keeping; video data; audio data; RADAR data; or LIDAR data.
Aspect 12. The method of any of Aspects 1 to 11, wherein forming the network comprises receiving, from at least one or the one or more targets, a reply to the network formation request.
Aspect 13. The method of Aspect 12 further comprising, based on receiving the reply to the network formation request, establishing a communications link with at least one of the one or more targets.
Aspect 14. The method of Aspect 12, further comprising receiving a first reply to the network formation request from a first target of the one or more targets over a first physical layer connection and receiving a second reply to the network formation request from a second target of the one or more targets over a second physical layer connection.
Aspect 15. The method of Aspect 14, wherein the first physical layer connection and the second physical layer connection utilize different communication protocols.
Aspect 16: The method of any of Aspects 1 to 15, wherein appending event data to the blockchain comprises at least one or more of obtaining an appendix order from a controlling device, sequentially appending event data from devices participating in the network, performing a branching reduction, performing a fork reduction, or generating a hashgraph.
Aspect 17. An apparatus for recording event data, comprising: at least one memory; and at least one processor coupled to at least one memory and configured to: generate a network formation request based on an event; broadcast the network formation request to one or more targets; form a network including at least one of the one or more targets; obtain, from at least one of the one or more targets, event data associated with the event; and append the event data associated with the event obtained from the one or more targets to a blockchain.
Aspect 18. The apparatus of Aspect 17, wherein, to generate the network formation request, the at least one processor is configured to generate an event ID, wherein the event ID comprises at least one or more of an event code, an event location, or an event time stamp.
Aspect 19. The apparatus of any of Aspects 17 to 18, wherein the at least one processor is configured to end the blockchain based on at least one or more of an amount of time or a blockchain length.
Aspect 20. The apparatus of Aspect 18, wherein, to end the blockchain, the at least one processor is configured to broadcast an end event request.
Aspect 21. The apparatus of any of Aspects 17 to 20, wherein the event data associated with the event comprises hashed event data corresponding to detailed event data collected from at least one of the one or more targets, wherein the hashed event data can be used to verify the detailed event data.
Aspect 22. The apparatus of any of Aspects 17 to 21, wherein the blockchain comprises a plurality of blocks, each block including at least a block hash and a payload.
Aspect 23. The apparatus of Aspect 22, wherein each block includes at least one block pointer.
Aspect 24. The apparatus of Aspect 22, wherein a block of the plurality of blocks includes hashed event data corresponding to detailed event data, wherein a data size associated with the hashed event data is less than a data size associated with the detailed event data.
Aspect 25. The apparatus of Aspect 24, wherein the detailed event data is stored outside of the blockchain.
Aspect 26. The apparatus of any of Aspects 17 to 25, wherein initiating the network formation request includes detecting the event by at least one or more of a roadside unit, a vehicle, or a mobile device.
Aspect 27. The apparatus of any of Aspects 17 to 26, wherein the network includes a V2X network and the event data associated with the event comprises at least one or more of: vehicle data logs, wherein the vehicle data logs include data related to at least one or more of acceleration, braking, turning, or distance keeping; video data; audio data; RADAR data; or LIDAR data.
Aspect 28. The apparatus of any of Aspects 17 to 27, wherein forming the network comprises receiving, from at least one or the one or more targets, a reply to the network formation request.
Aspect 29. The apparatus of Aspect 28, wherein the at least one processor is configured to: base on receiving the reply to the network formation request, establish a communications link with at least one of the one or more targets.
Aspect 30. The apparatus of Aspect 28, wherein the at least one processor is configured to: receive a first reply to the network formation request from a first target of the one or more targets over a first physical layer connection and receiving a second reply to the network formation request from a second target of the one or more targets over a second physical layer connection.
Aspect 31. The apparatus of any of Aspect 17 to Aspect 30, wherein the first physical layer connection and the second physical layer connection utilize different communication protocols.
Aspect 32. The apparatus of any of Aspects 17 to 31, wherein, to append event data to the blockchain, the at least one process is configured to at least one or more of: obtain an appendix order from a controlling device, sequentially append event data from devices participating in the network, perform a branching reduction, perform a fork reduction, or generate a hashgraph.
Aspect 33. A non-transitory computer-readable storage medium having stored thereon instructions which, when executed by one or more processors, cause the one or more processors to perform any of the operations of aspects 1 to 32.
Aspect 34. An apparatus comprising means for performing any of the operations of aspects 1 to 32. :

1. A method for recording event data comprising:
generating a network formation request based on an event;
broadcasting the network formation request to one or more targets;
forming a network including at least one of the one or more targets;
obtaining, from at least one of the one or more targets, event data associated with the event; and
appending the event data associated with the event obtained from the one or more targets to a blockchain.

2. The method of claim 1, wherein generating the network formation request comprises generating an event identifier (ID), wherein the event ID comprises at least one or more of an event code, an event location, or an event time stamp.

3. The method of claim 1, further comprising ending the blockchain based on at least one or more of an amount of time or a blockchain length.

4. The method of claim 3, wherein ending the blockchain comprises broadcasting an end event request.

5. The method of claim 1, wherein the event data associated with the event comprises hashed event data corresponding to detailed event data collected from at least one of the one or more targets, wherein the hashed event data can be used to verify the detailed event data.

6-15. (canceled)

16. An apparatus for recording event data, comprising:
at least one memory; and
at least one processor coupled to at least one memory and configured to:
generate a network formation request based on an event;
broadcast the network formation request to one or more targets;
form a network including at least one of the one or more targets;
obtain, from at least one of the one or more targets, event data associated with the event; and
append the event data associated with the event obtained from the one or more targets to a blockchain.

17. The apparatus of claim 16, wherein, to generate the network formation request, the at least one processor is configured to generate an event ID, wherein the event ID comprises at least one or more of an event code, an event location, or an event time stamp.

18. The apparatus of claim 16, wherein the at least one processor is configured to end the blockchain based on at least one or more of an amount of time or a blockchain length.

19. The apparatus of claim 18, wherein, to end the blockchain, the at least one processor is configured to broadcast an end event request.

20. The apparatus of claim 16, wherein the event data associated with the event comprises hashed event data corresponding to detailed event data collected from at least one of the one or more targets, wherein the hashed event data can be used to verify the detailed event data.

21. The apparatus of claim 16, wherein the blockchain comprises a plurality of blocks, each block including at least a block hash and a payload.

22. The apparatus of claim 21, wherein each block includes at least one block pointer.

23. The apparatus of claim 21, wherein a block of the plurality of blocks includes hashed event data corresponding to detailed event data, wherein a data size associated with the hashed event data is less than a data size associated with the detailed event data.

24. The apparatus of claim 23, wherein the detailed event data is stored outside of the blockchain.

25. The apparatus of claim 16, wherein initiating the network formation request includes detecting the event by at least one or more of a roadside unit, a vehicle, or a mobile device.

26. The apparatus of claim 16, wherein the network includes a V2X network and the event data associated with the event comprises at least one or more of:
vehicle data logs, wherein the vehicle data logs include data related to at least one or more of acceleration, braking, turning, or distance keeping;
video data;
audio data;
RADAR data; or
LIDAR data.

27. The apparatus of claim 16, wherein forming the network comprises receiving, from at least one or the one or more targets, a reply to the network formation request.

28. The apparatus of claim 27, wherein the at least one processor is configured to: base on receiving the reply to the network formation request, establish a communications link with at least one of the one or more targets.

29. The apparatus of claim 27, wherein the at least one processor is configured to: receive a first reply to the network formation request from a first target of the one or more targets over a first physical layer connection and receiving a second reply to the network formation request from a second target of the one or more targets over a second physical layer connection.

30. The apparatus of claim 29, wherein the first physical layer connection and the second physical layer connection utilize different communication protocols.
